(19) United States
(12) Patent Application Publication
(10) Pub. No.: US 2024/0286514 A1
(43) Pub. Date: Aug. 29, 2024

(54) Charging Control Method, Charging Control Device and Charging Device

(71) Applicant: AUTEL Digital Power Co., ltd., Shenzhen (CN)

(72) Inventors: Songsong QU, Shenzhen (CN); Guangwen FENG, Shenzhen (CN)

(73) Assignee: Autel Digital Power Co., Ltd., Shenzhen, GD (CN)

(21) Appl. No.: 18/572,191

(22) PCT Filed: May 27, 2022
(86) PCT No.: PCT/CN2022/095718

§ 371 Date: Dec. 20, 2023

(30) Foreign Application Priority Data
Jun. 21, 2021 (CN) 202110687359.0

(51) Int. Cl. B60L 53/62; B60L 53/16; B60L 53/30; B60L 58/12; H02J 7/00

(52) U.S. Cl. CPC B60L 53/62; B60L 53/16; B60L 53/305; B60L 58/12; H02J 7/00036; H02J 7/0048; H02J 7/00712

(57) ABSTRACT

A charging control method, a charging control device and a charging device are disclosed, wherein the charging control method is applied to the charging device, and the charging device is used for charging an electric vehicle, while the method includes: acquiring a charging current of a battery of the electric vehicle during a charging process; acquiring an electric quantity data value of the battery on the basis of a charging current of the battery and a correspondence relationship between the charging current and the electric quantity data value of the battery; and controlling the charging process of the battery on the basis of the electric quantity data value. In this way, it is possible to control the charging process of the battery in a relatively simple manner to extend the service life of the battery.

The present application claims priority to Chinese Patent Application No. 202110687359.0, entitled “CHARGING CONTROL METHOD, CHARGING CONTROL DEVICE, AND CHARGING DEVICE”, filed on Jun. 21, 2021 with the China National Intellectual Property Administration, the entire contents of which are incorporated herein by reference.

### TECHNICAL FIELD

The present application relates to the technical field of charging, and in particular to a charging control method and device and a charging device.

### BACKGROUND

Automotive exhaust is one of the main causes of environmental pollution, and electric vehicles have emerged in recent years. Electric vehicles are powered by electrical energy, energy-saving and environmental protection, and are actively encouraged by the government, which quickly enter people's vision, and are loved by the general public. At present, charging of electric vehicles is mainly accomplished through charging devices (e.g. charging piles).

However, the current charging device on the market can only charge the electric automobile, and cannot obtain the electric quantity data value of the battery of the electric automobile during the charging process in real time, so as to control the charging process of the electric automobile, namely, the charging process of the electric automobile is an uncontrollable process. For example, the charging process cannot be stopped in time when the battery is fully charged, and in this case, an abnormality of overcharging the battery may occur, which affects the service life of the battery.

### SUMMARY

Embodiments of the present application aim to provide a charging control method and device and a charging device that can control the charging process of a battery in a relatively simple manner to extend the service life of the battery.

To achieve the object, in a first aspect, the present application provides a charging control method, applied to a charging device for charging an electric vehicle, wherein the method comprises:
acquiring a charging current of a battery of the electric vehicle during a charging process;
acquiring an electric quantity data value of the battery on the basis of a charging current of the battery and a correspondence relationship between the charging current and the electric quantity data value of the battery; and
controlling the charging process of the battery on the basis of the electric quantity data value.

In an optional aspect, the charging device comprises a CP detection module; and
before acquiring a charging current of a battery of the electric vehicle during a charging process, the method further comprises:
detecting whether a charging gun is inserted into a charging interface of the electric vehicle by the CP detection module; and
if the CP detection module detects that a charging gun is inserted into a charging interface of the electric vehicle, performing the step of acquiring a charging current of a battery of the electric vehicle during a charging process.

In an optional aspect, the method further comprises, before acquiring an electric quantity data value of the battery on the basis of a charging current of the battery and a correspondence relationship between the charging current and the electric quantity data value of the battery:
acquiring data information of the electric vehicle; and
acquiring a correspondence relationship between the charging current of the battery of the electric vehicle during the charging process and the electric quantity data value on the basis of the data information.

In an alternative aspect, before controlling the charging process of the battery on the basis of the electric quantity data value, the method further comprises:
acquiring a charging mode of the electric vehicle; and
the controlling the charging process of the battery on the basis of the electric quantity data value comprises:
controlling the charging process of the battery on the basis of the charging mode and the electric quantity data value.

In an alternative aspect, the electric quantity data value is an SOC value, the SOC value being a ratio of a remaining electric quantity of the battery to a nominal capacity of the battery.

In an optional aspect, the controlling the charging process of the battery on the basis of the charging mode and the electric quantity data value comprises:
if the charging mode is a healthy mode, ending the charging process of the battery when the SOC value is greater than or equal to a first preset threshold, the first preset threshold being less than 1.

In an optional aspect, the controlling the charging process of the battery on the basis of the charging mode and the electric quantity data value comprises:
if the charging mode is a normal mode, ending the charging process of the battery when the SOC value is greater than or equal to 1.

In an alternative aspect, the charging device comprises a display module; and
after the acquiring the electric quantity data value of the battery, the method further comprises:
displaying the electric quantity data value of the battery in real time via the display module.

In an alternative aspect, the data information of the electric vehicle includes a train system and a year of production of the electric vehicle.

In a second aspect, the present application provides a charging control device, applied to a charging device for charging an electric vehicle, wherein the charging control device comprises:
a first acquisition unit for acquiring a charging current of a battery of the electric vehicle during a charging process;
a second acquisition unit for acquiring an electric quantity data value of the battery on the basis of a charging current of the battery and a correspondence relationship between the charging current and the electric quantity data value of the battery; and
a charging process control unit for controlling the charging process of the battery on the basis of the electric quantity data value.

In a third aspect, the present application provides a charging device comprising:
a CP detection module for detecting whether a charging gun is inserted into a charging interface of an electric vehicle;
a control module connected to the CP detection module for controlling a charging process of a battery of the electric vehicle when the CP detection module detects that the charging gun is inserted into the charging interface of the electric vehicle, the control module comprising:
at least one processor and a memory communicatively coupled to the at least one processor, the memory storing instructions executable by the at least one processor, the instructions being executable by the at least one processor to enable the at least one processor to perform the method as described above.

In an optional aspect, the charging device further comprises:
a sampling module for collecting a charging current of the battery of the electric vehicle during the charging process; and
a display module for displaying an electric quantity data value of the battery in real time.

In an alternative aspect, the charging device is a charging pile.

In a fourth aspect, the present application provides a computer-readable storage medium, having stored thereon computer-executable instructions that, when executed by a charging device, cause the charging device to perform the method as described above.

Advantageous effects of the embodiments of the present application are as follows. The charging control method provided in the present application is applied to a charging device for charging an electric vehicle, and the charging device is used for charging the electric vehicle. The method comprises acquiring a charging current of a battery of the electric vehicle during a charging process; acquiring an electric quantity data value of the battery on the basis of a charging current of the battery and a correspondence relationship between the charging current and the electric quantity data value of the battery; and controlling the charging process of the battery on the basis of the electric quantity data value. When the battery of the electric vehicle is charged, only the charging current during the charging process needs to be acquired, so that the charging process of the battery can be controlled in a relatively simple manner. By controlling the charging process of the battery, it is also possible to stop the charging process when the battery is charged to a preset amount, thereby avoiding an overcharge phenomenon and extending the service life of the battery.

### BRIEF DESCRIPTION OF THE DRAWINGS

One or more embodiments are illustrated by way of examples, which do not constitute limitation on the embodiments, in the figures of the corresponding accompanying drawings, in which elements having the same reference numeral designations represent similar elements, and in which the figures are not to scale unless otherwise specified.

FIG. 1 is a schematic diagram of an application scenario provided by an embodiment of the present application;

FIG. 2 is a structural schematic diagram of a charging device according to an embodiment of the present application;

FIG. 3 is a structural schematic diagram of a charging device according to another embodiment of the present application;

FIG. 4 is a flowchart of a charging control method according to an embodiment of the present application;

FIG. 5 is a structural schematic diagram of a charging control device according to an embodiment of the present application.

### DETAILED DESCRIPTION OF THE INVENTION

In order that the objects, aspects and advantages of the embodiments of the present application will become more apparent, a more clear and complete description of the embodiments of the present application will be rendered by reference to the appended drawings. The described embodiments are a part of, not all of the embodiments of the present application. On the basis of the embodiments in the present application, all the other embodiments obtained by a person of ordinary skill in the art without involving any inventive effort fall within the scope of protection of the present application.

In order to facilitate an understanding of the present application, a description is first given of the following application scenarios to which the present application may be applied, with reference to FIG. 1. FIG. 1 is an application scenario of a charging control method provided by an embodiment of the present application, in which an electric vehicle 10 and a charging pile 20 are included.

As shown in FIG. 1, an electric vehicle 10 is provided with a BMS 11 (BMS is collectively referred to as a battery management system) and a power battery 12 (for example, a lithium battery), wherein the BMS 11 is a set of control systems for protecting the use safety of the power battery 12, and the use state of the power battery 12 is monitored at all times. A charging pile 20 is used to charge the lithium battery 12, which charging process needs to be controlled by the BMS 11. Thus, during a charging process, the BMS 11 can control the manner in which the charging pile 20 charges the power battery 12, such as a constant current charging manner or a variable current charging manner. At the same time, the BMS 11 can also control the magnitude of the charging current that the charging pile 11 charges the power battery 12 and the change in the parameter of the power battery 12.

When a charging gun 21 of the charging pile 20 is inserted into a charging interface of the electric vehicle 10, the charging pile 20 begins to charge the power battery 12 in the electric vehicle 10. At the same time, the charging pile 20 can learn an electric quantity data value of the power battery 12 during the charging process in real time, such as an SOC value, wherein the SOC value is a ratio of the remaining electric quantity of the battery to a nominal capacity of the battery. During the charging process of the battery, the SOC value will change continuously, and by acquiring the SOC value during the charging process in real time, the data value can be used to determine how much the electric quantity of the power battery 12 currently has. On the one hand, the SOC value can be displayed in real time via the charging pile, so that the user can know how much power battery 12 has been charged and how long it can be filled, which brings convenience to the user. For example, the user can estimate the time when power battery 12 is fully charged, so that the user can better grasp the approximate time when the user can take the vehicle. On the other hand, the charging pile can also determine the moment of stopping the charging of the battery according to the obtained electric quantity data value, and stop the charging process in time when the battery is charged to a preset electric quantity, so that it is possible to prevent the battery from being overcharged and affecting the service life of the battery.

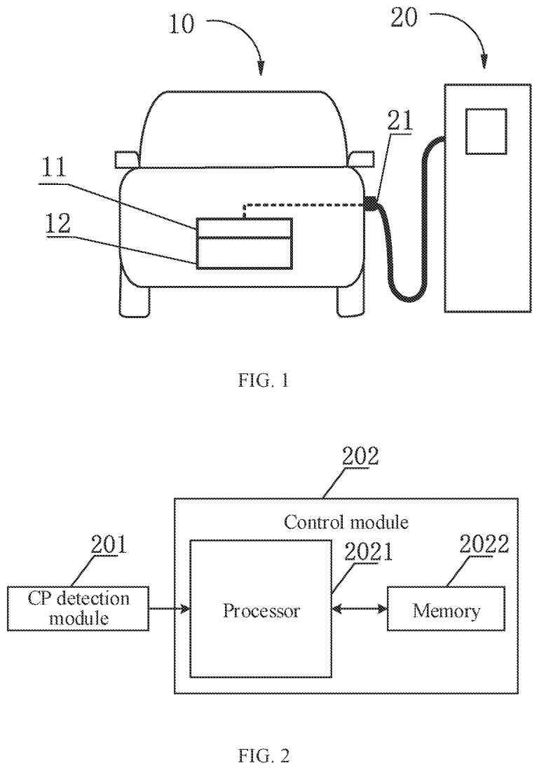

Illustratively, with reference to FIG. 2, a schematic diagram of a hardware structure of one possible charging device that may be used to implement the charging control method provided by an embodiment of the present application is shown.

As shown in FIG. 2, the charging device comprises a CP detection module 201 and a control module 202, wherein in the charging device, a control pilot (CP) signal is a signal for detecting whether the charging device is connected to the electric vehicle, so the CP detection module 201 can be used for detecting whether the charging gun is plugged into the charging interface of the electric vehicle, wherein if it is detected that no charger is plugged into the charging interface of the electric vehicle, it may be that the charger is unplugged from the charging interface or that the charging interface has not been plugged into.

The control module 202 is connected to the CP detection module 201, and when the CP detection module 201 detects that the charging gun is inserted into the charging interface of the electric vehicle, the control module 202 can learn that the charging gun is inserted into the charging interface through the CP detection module 201, so that the control module 202 can further control the charging process of the battery of the electric vehicle. For example, when the control module 202 learns that the charger is inserted into the charging interface of the electric vehicle, namely, the charging process of the battery is controlled to start.

The control module 202 may employ, among other things, a microcontroller unit (MCU) or digital signal processing (DSP) controller.

The control module 202 comprises at least one processor 2021 and a memory 2022, wherein the memory 2022 can be built in the control module 202 or external to the control module 202, and the memory 2022 can also be a remotely arranged memory, and connected to the control module 202 via a network.

The memory 2022 serves as a non-volatile computer-readable storage medium for storing non-volatile software programs, non-volatile computer-executable programs, and modules. The memory 2022 can comprise a program storage area and a data storage area, wherein the program storage area can store an operating system and an application program required by at least one function; the data storage area may store data created according to the use of the terminal, etc. In addition, the memory 2022 may include high speed random access memory and may also include non-volatile memory, such as at least one magnetic disk storage device, flash memory device, or other non-volatile solid state storage device. In some embodiments, the memory 2022 may optionally include a memory remotely located with respect to processor 2021, which may be connected to the terminal via a network. Examples of such networks include, but are not limited to, the Internet, intranets, local area networks, mobile communication networks, and combinations thereof.

The processor 2021 performs various functions of the terminal and processes data by running or executing software programs and/or modules stored in the memory 2022 and invoking data stored in the memory 2022 to monitor the terminal as a whole, for example to implement the charging control method according to any of the embodiments of the present application.

The processors 2021 may be one or more, with one processor 2021 being exemplified in FIG. 1. The processor 2021 and memory 2022 may be connected by a bus or other means. The processor 2021 may include a central processing unit (CPU), a digital signal processor (DSP), an application specific integrated circuit (ASIC), a controller, a field programmable gate array (FPGA) device, etc. The processor 2021 may also be implemented as a combination of computing devices, e.g. a combination of a DSP and a microprocessor, a plurality of microprocessors, one or more microprocessors in conjunction with a DSP core, or any other such configuration.

It should be noted that the hardware structure of the charging device as shown in FIG. 2 is merely an example, and that the charging device may have more or less components than those shown in the figure, may combine two or more components, or may have different component configurations, and that the various components shown in the figure may be implemented in hardware, software, or a combination of hardware and software including one or more signal processing and/or application specific integrated circuits.

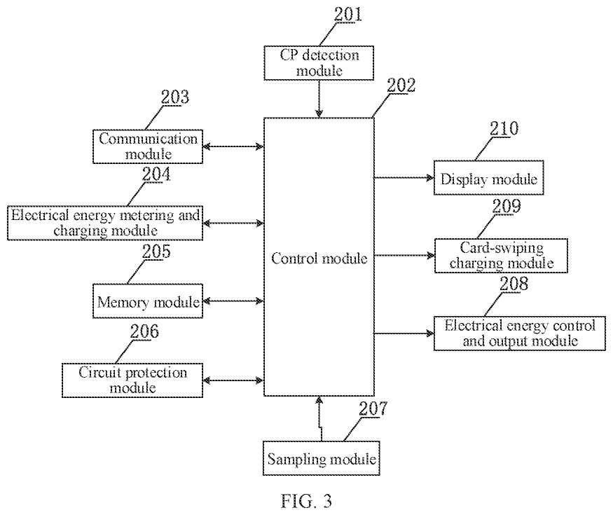

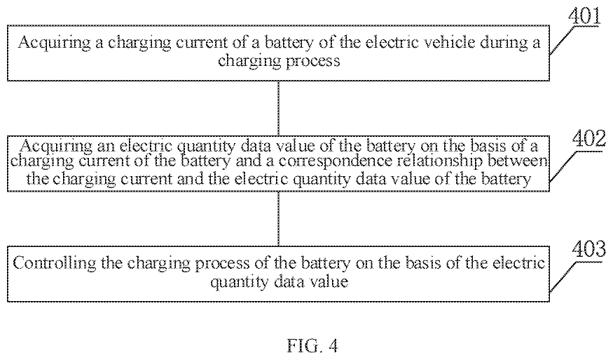

For example, as shown in FIG. 3, the charging device further comprises a communication module 203, an electrical energy metering and charging module 204, a memory module 205, a circuit protection module 206, a sampling module 207, an electrical energy control and output module 208, a card-swiping charging module 209 and a display module 210. Each of these modules is connected to and controlled by the control module 202.

The control module 202 communicates data with a server, an intelligent terminal (e.g. a mobile phone), an electric vehicle, etc. via a communication module 203 via WIFI, bluetooth, 4G, CAN, etc. For example, if the control module 202 communicates with the handset via the communication module 203, the handset may receive data such as the current charging current of the battery from the control module 207.

According to the detected charging current of the battery, the electrical energy metering and charging module 204 uses an ampere-hour integration method, namely, integrating the charging current within a preset time period, so as to obtain the metering of the electrical energy charged into the electric vehicle within the preset time period. Further, the electrical energy metering and charging module 204 may determine a fee to be charged on the basis of the charging criteria and the metering of the electrical energy charged to the electric vehicle.

The memory module 205 can store relevant data (e.g. a charging current) during the charging process, and can also store a mapping relationship between a preset charging current and an electric quantity data value (e.g. an SOC (State of Charge) value, a battery state-of-charge value, also referred to as a remaining electric quantity).

The circuit protection module 206 is used to protect the charging device from over-voltage or over-current to prevent damage to the charging device or the electric vehicle.

The sampling module 207 is used for collecting the charging current of the battery of the electric vehicle during the charging process, and at the same time, the sampling module 207 can also collect parameters such as voltage or temperature so as to provide effective data for the calculation of electric quantity, the control of temperature and the protection of circuit.

The electrical energy control and output module 208 is used to control the input electrical energy of the charging device to the electric vehicle, for example, the electrical energy control and output module 208 may control parameters such as a maximum output current of the charging device to the electric vehicle.

The card-swiping charging module 209 is used for realizing the charging function of the charging device.

The display module 210 is used for interacting with a user, and the display module 210 can display contents such as the electric quantity during charging, the fee required to be paid by the user, and the SOC value of the battery of the electric vehicle.

Therefore, the charging device can realize communication and interaction of data with an external device, control of parameters of a charging process, display of battery-related data of the electric vehicle, and metering and charging of electric quantity.

In one embodiment, the charging device is a charging pile, a charging gun is provided on the charging pile, a battery of the electric vehicle can be charged by inserting the charging gun into a charging interface of the electric vehicle, and at the same time, the charging pile can control a control process of the battery.

FIG. 4 is a schematic flow chart of a charging control method according to an embodiment of the present application, which is applied to a charging device for charging an electric vehicle. The method may be performed by a charging device as shown in FIG. 1, FIG. 2 or FIG. 3, the method comprising, as shown in FIG. 4:

Step 401: a charging current of a battery of an electric vehicle is acquired during a charging process.

In one embodiment, if the charging device includes the CP detection module 201 as shown in FIG. 2 or FIG. 3, the CP detection module 201 may be used to detect whether a charging gun is inserted into a charging interface of the electric vehicle before acquiring the charging current of the battery of the electric vehicle during the charging process.

Then, if the CP detection module 201 does not detect that the charging gun is inserted into the charging interface of the electric vehicle, it is not necessary to execute step 401, and the execution of step 401 is started only when the CP detection module 201 detects that the charging gun is inserted into the charging interface of the electric vehicle, so that the detection accuracy can be improved.

Step 402: an electric quantity data value of the battery is acquired on the basis of a charging current of the battery and a correspondence relationship between the charging current and the electric quantity data value of the battery.

In one embodiment, the correspondence relationship between the charging current and the electric quantity data value of the battery may be obtained by first acquiring data information of the electric vehicle and then acquiring the correspondence relationship between the charging current and the electric quantity data value of the battery according to the data information. The data information about the electric vehicle may include a train system of the electric vehicle and a year of production; the electric quantity data value may be aN SOC value or a remaining electric quantity value of the battery.

Taking the electric quantity data value as an example of the SOC value, the correspondence relationship between the charging current and the SOC value can also be referred to as a mapping relationship between the charging current and the SOC value, namely, one-to-one correspondence between the charging current and the SOC value. Then, for an electric vehicle with the same data information, the charging current and the SOC value thereof can be fitted into a curve.

Specifically, a large number of data can be collected according to the mapping data between the charging current and the SOC value of the batteries of electric vehicles of different vehicle systems and different years, and then the data can be fitted according to the batteries of different vehicle systems and different years, so as to fit a charging current-SOC value curve of the power battery, and ensure that the curve conforms to the overall charging current-SOC value change curve of the batteries of the vehicle system and the year. Thus, a charging current-SOC value curve, i.e. a current-SOC value mapping table, exists for power batteries of different vehicle systems and different years, so that a charging current-SOC value mapping database can be formed. Finally, the database is stored in the charging device in advance.

It can be seen that the charging device only needs to acquire data information about the charging current and the electric vehicle, then a charging current-SOC value mapping table corresponding to the battery of the electric vehicle can be obtained, and then the charging current is substituted into the charging current-SOC value mapping table, and then the SOC value of the current battery can be directly obtained.

Furthermore, if the charging device comprises a display module 210 as shown in FIG. 3, after acquiring the electric quantity data value of the battery, the electric quantity data value can be displayed on the display module 210, so that a user can know through the display module 210 how much the electric quantity value of the battery has been charged specifically, and can also know the approximate time point when the charging process ends, which is beneficial for the user to better schedule his own time, namely, providing convenience for the user.

Step 403: the charging process of the battery is controlled on the basis of the electric quantity data value.

The electric quantity data value mainly refers to the current electric quantity value of the battery, which can be reflected by the SOC value or the remaining electric quantity of the battery. If the charging device can know the electric quantity data value of the battery of the electric vehicle, the electric vehicle can know how much electric quantity the battery has been charged according to the electric quantity data value obtained in real time, and then the charging process can be ended in time when the electric quantity of the battery is full, so as to prevent the battery from affecting its service life due to over-charging.

In an embodiment, the charging mode required by the electric vehicle is further acquired and the charging process of the battery is controlled in combination with the charging mode of the electric vehicle and the electric quantity data value, wherein the charging mode of the electric vehicle may include a healthy mode and a normal mode.

Specifically, the SOC value being the electric quantity data value is described as an example.

If the charging mode is the healthy mode, the charging process of the battery is ended when the SOC value is greater than or equal to a first preset threshold. The first preset threshold is less than 1. Since the SOC value is a ratio less than or equal to 1, that is to say, the maximum value of the SOC value is 1, at this time, the first preset threshold value is set to be less than 1 so as to control that the SOC value does not reach 1 during the charging process of the battery, that is to say, the battery does not reach a fully charged state. This is because, in general, a rechargeable battery is a lithium battery, and the physical characteristics of the lithium battery determine that a battery with a shallow charge and a shallow discharge (i.e. not fully charged and fully discharged) can obtain a longer battery life. Therefore, the control stops the charging process when the SOC value is less than 1, and the service life of the battery can be extended. For example, by setting the first preset threshold to 80%, in the healthy mode, when the charging device detects that the SOC value of the battery has been greater than or equal to 80%, i.e. the charging process of the battery is switched off, the battery is no longer charged.

If the charging mode is the normal mode, the charging process of the battery is ended when the SOC value of the battery is greater than or equal to 1. In this mode, the charging process of the battery is interrupted and the charging of the battery is stopped only if the charging device detects that the SOC value of the battery is 100%. At this time, the electric quantity of the battery is full, so that the user can use the battery for a longer time.

Therefore, when the user needs to continuously use the electric vehicle for a long period of time, the charging mode may be set to the normal mode to meet the demand, and during daily use, for example, when the electric vehicle is used for commuting in a short distance, the charging mode may be set to the healthy mode to extend the service life of the battery.

In summary, in the present application, firstly, a mapping table of charging current and electric quantity data values is fitted using a large number of collected correspondence relationship data of the charging current and SOC. Then, according to the data information of the detected charging current and the electric vehicle, a corresponding electric quantity data value can be found from a mapping table of the charging current and the electric quantity data value, and the electric quantity data value is displayed via a display module of the charging device, so as to bring convenience to the user and improve the user experience. Finally, by controlling the charging process of the battery according to the electric quantity data value, it is possible not only to stop the charging process of the battery in time so as to prevent damage to the battery caused by overcharge, but also to extend the service life of the battery by charging in the healthy mode.

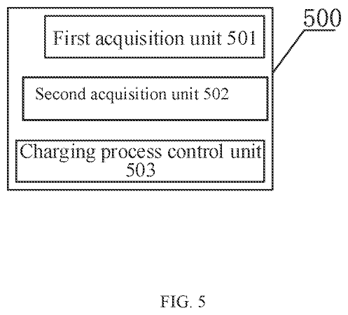

FIG. 5 is a structural schematic diagram of a charging control device according to an embodiment of the present application. As shown in FIG. 5, the charging control device 500 includes a first acquisition unit 501, a second acquisition unit 502, and a charging process control unit 503.

The first acquisition unit 501 serves to acquire a charging current of a battery of the electric vehicle during a charging process. The second acquisition unit 502 is used for acquiring the electric quantity data value of the battery on the basis of the charging current of the battery and the correspondence relationship between the charging current and the electric quantity data value of the battery. The charging process control unit 503 is used to control the charging process of the battery on the basis of the electric quantity data value.

Since the device embodiment and the method embodiment are on the basis of the same concept, the contents of the device embodiment may refer to the method embodiment without the contents conflicting with each other, and the description thereof will not be repeated.

Embodiments of the present application also provide a computer-readable storage medium having stored thereon computer-executable instructions that, when executed by a charging device, cause the charging device to perform the method as described in any of the embodiments above.

Embodiments of the invention also provide a computer program product comprising a computer program stored on a computer readable storage medium, the computer program comprising program instructions which, when executed by a computer, cause the computer to perform the method as described in any one of the embodiments above.

Finally, it should be noted that: the above-mentioned embodiments are merely illustrative of the technical solution of the present application, and do not limit same. Under the idea of the present application, the technical features in the embodiments or in different embodiments may also be combined, the steps may be implemented in any order, and there are many other variations of the different aspects of the present application as described above, which are not provided in detail for the sake of brevity. Although the present application has been described in detail with reference to the foregoing embodiments, those skilled in the art will appreciate that: the technical solutions disclosed in the above-mentioned embodiments can still be amended, or some of the technical features thereof can be replaced by equivalents. However, these modifications or substitutions do not bring the essence of the corresponding technical solutions out of the scope of the technical solutions of the various embodiments of the present application.

1. A charging control method, applied to a charging device for charging an electric vehicle, wherein the method comprises:
acquiring a charging current of a battery of the electric vehicle during a charging process;
acquiring an electric quantity data value of the battery on the basis of a charging current of the battery and a correspondence relationship between the charging current and the electric quantity data value of the battery; and
controlling the charging process of the battery on the basis of the electric quantity data value.

2. The method according to claim 1, wherein the charging device comprises a CP detection module; and
before acquiring a charging current of a battery of the electric vehicle during a charging process, the method further comprises:
detecting whether a charging gun is inserted into a charging interface of the electric vehicle by the CP detection module; and
if the CP detection module detects that a charging gun is inserted into a charging interface of the electric vehicle, performing the step of acquiring a charging current of a battery of the electric vehicle during a charging process.

3. The method according to claim 1, wherein the method further comprises, before acquiring an electric quantity data value of the battery on the basis of a charging current of the battery and a correspondence relationship between the charging current and the electric quantity data value of the battery:
acquiring data information of the electric vehicle; and
acquiring a correspondence relationship between the charging current of the battery of the electric vehicle during the charging process and the electric quantity data value on the basis of the data information.

4. The method according to claim 1, wherein, before controlling the charging process of the battery on the basis of the electric quantity data value, the method further comprises:
acquiring a charging mode of the electric vehicle; and
the controlling the charging process of the battery on the basis of the electric quantity data value comprises:
controlling the charging process of the battery on the basis of the charging mode and the electric quantity data value.

5. The method according to claim 4, wherein the electric quantity data value is an SOC value, the SOC value being a ratio of a remaining electric quantity of the battery to a nominal capacity of the battery.

6. The method according to claim 5, wherein the controlling the charging process of the battery on the basis of the charging mode and the electric quantity data value comprises:
if the charging mode is a healthy mode, ending the charging process of the battery when the SOC value is greater than or equal to a first preset threshold, the first preset threshold being less than 1.

7. The method according to claim 5, wherein the controlling the charging process of the battery on the basis of the charging mode and the electric quantity data value comprises:
if the charging mode is a normal mode, ending the charging process of the battery when the SOC value is greater than or equal to 1.

8. The method according to claim 1, wherein the charging device comprises a display module; and
after the acquiring the electric quantity data value of the battery, the method further comprises:
displaying the electric quantity data value of the battery in real time via the display module.

9. The method according to claim 1, wherein the data information of the electric vehicle includes a train system and a year of production of the electric vehicle.

10. A charging control device, applied to a charging device for charging an electric vehicle, wherein the charging control device comprises at least one processor and a memory communicatively coupled to the at least one processor, the memory storing instructions executable by the at least one processor, the instructions being executable by the at least one processor to enable the at least one processor to perform the method comprising steps of:
acquiring a charging current of a battery of the electric vehicle during a charging process;
acquiring an electric quantity data value of the battery on the basis of a charging current of the battery and a correspondence relationship between the charging current and the electric quantity data value of the battery; and
controlling the charging process of the battery on the basis of the electric quantity data value.

11. A charging device comprising:
a CP detection module for detecting whether a charging gun is inserted into a charging interface of an electric vehicle;
a control module connected to the CP detection module for controlling a charging process of a battery of the electric vehicle when the CP detection module detects that the charging gun is inserted into the charging interface of the electric vehicle, the control module comprising:
at least one processor and a memory communicatively coupled to the at least one processor, the memory storing instructions executable by the at least one processor, the instructions being executable by the at least one processor to enable the at least one processor to perform the method comprising steps of:
acquiring a charging current of a battery of the electric vehicle during a charging process;
acquiring an electric quantity data value of the battery on the basis of a charging current of the battery and a correspondence relationship between the charging current and the electric quantity data value of the battery; and
controlling the charging process of the battery on the basis of the electric quantity data value.

12. The charging device according to claim 11, wherein the charging device further comprises:
a sampling module for collecting a charging current of the battery of the electric vehicle during the charging process; and
a display module for displaying an electric quantity data value of the battery in real time.

13. The charging device according to claim 11, wherein the charging device is a charging pile.

14. (canceled)

15. The device according to claim 10, wherein the charging device comprises a CP detection module; before the processor executes the step of acquiring a charging current of a battery of the electric vehicle during a charging process, the at least one processor further executes a step of:
detecting whether a charging gun is inserted into a charging interface of the electric vehicle by the CP detection module; and
if the CP detection module detects that a charging gun is inserted into a charging interface of the electric vehicle, performing the step of acquiring a charging current of a battery of the electric vehicle during a charging process.

16. The device according to claim 10, wherein before the at least one processor executes the step of acquiring an electric quantity data value of the battery on the basis of a charging current of the battery and a correspondence relationship between the charging current and the electric quantity data value of the battery, the at least one processor further executes a step of:
acquiring data information of the electric vehicle; and
acquiring a correspondence relationship between the charging current of the battery of the electric vehicle during the charging process and the electric quantity data value on the basis of the data information.

17. The device according to claim 10, wherein, before the at least one processor executes the step of controlling the charging process of the battery on the basis of the electric quantity data value, the at least one processor further executes a step of:
acquiring a charging mode of the electric vehicle; and
the controlling the charging process of the battery on the basis of the electric quantity data value comprises:
controlling the charging process of the battery on the basis of the charging mode and the electric quantity data value.

18. The device according to claim 17, wherein the electric quantity data value is an SOC value, the SOC value being a ratio of a remaining electric quantity of the battery to a nominal capacity of the battery.

19. The device according to claim 18, wherein the at least one processor executes the step of controlling the charging process of the battery on the basis of the charging mode and the electric quantity data value, the at least one processor further executes a step of:
if the charging mode is a healthy mode, ending the charging process of the battery when the SOC value is greater than or equal to a first preset threshold, the first preset threshold being less than 1.

20. The device according to claim 18, wherein the at least one processor executes the step of controlling the charging process of the battery on the basis of the charging mode and the electric quantity data value, the at least one processor further executes a step of:
if the charging mode is a normal mode, ending the charging process of the battery when the SOC value is greater than or equal to 1.

21. The device according to claim 10, wherein the charging device comprises a display module; and after the at least one processor executes the step of acquiring an electric quantity data value of the battery, the at least one processor further executes a step of:
displaying the electric quantity data value of the battery in real time via the display module.
